(19) United States
(12) Patent Application Publication
(10) Pub. No.: US 2026/0242031 A1
(43) Pub. Date: Aug. 20, 2026

(54) OFF-ROAD MOTORCYCLE

(71) Applicant: ZHEJIANG FEISHEN IMP.&EXP.CO.,LTD, Jinhua (CN)

(72) Inventor: Xiangyang CHEN, Jinhua (CN)

(21) Appl. No.: 19/184,916

(22) Filed: Apr. 21, 2025

(30) Foreign Application Priority Data
Feb. 14, 2025 (CN) 202520231116.X
Feb. 14, 2025 (CN) 202520231117.4
Feb. 14, 2025 (CN) 202520231118.9

(51) Int. Cl. B62K 25/26; B62K 11/02

(52) U.S. Cl. CPC B62K 25/26; B62K 11/02

(57) ABSTRACT

Disclosed is an off-road motorcycle, which comprises a frame and a rear fork pivotally connected to the frame, by arranging two connecting rods in different positions, which are namely a first connecting rod and a second connecting rod, when a shock absorption action is needed, by means of a quadrilateral principle, the first connecting rod is subjected to an acting force after deflection of the rear fork and the acting force is progressively dispersed to the second connecting rod until the acting force is transmitted to a shock absorber, so as to form a two-stage acting force, thereby obtaining a better shock absorption effect.

### CROSS REFERENCE TO RELATED APPLICATIONS

This application claims foreign priority of Chinese Patent Application No. 202520231117.4 with a filing date of February 14, 2025, Chinese Patent Application No. 202520231116.X with a filing date of February 14, 2025, Chinese Patent Application No. 202520231118.9 with a filing date of February 14, 2025 in the China National Intellectual Property Administration, the disclosures of all of which are hereby incorporated by reference.

### TECHNICAL FIELD

The present application relates to the field of motorcycles, in particular to an off-road motorcycle.

### BACKGROUND OF THE PRESENT INVENTION

An existing common rear shock absorption system of a motorcycle may refer to a connecting structure of a rear shock absorber of an off-road motorcycle provided by Chines patent application number CN2008200510697. Specifically, the connecting structure comprises a frame [1], a rear shock absorber [2], a rear bottom fork [3], a rocker [4] and a pull rod [5], wherein an upper end of the rear shock absorber [2] is connected with the frame [1] by a No. 4 pin [7], the rear bottom fork [3] is connected with the frame [1] by a No. 5 pin [8], the pull rod [5] is connected with the frame [1] by a No. 6 pin [9], a rotating hinge support of the rocker (4) is a No. 3 pin , [6c] and the No. 3 pin [6c] is arranged on the rear bottom fork [3]. Because a main body structure of the rocker [4] is arranged at and above the rear bottom fork [3], a rocker ratio of the rocker [4] may be larger. Meanwhile, the rear shock absorber [2] has a smaller relative swinging amplitude with the frame [1] when working, so that the rear shock absorber [2] has a good stress condition and compact distribution.

One of objectives of the present application is to develop a new rear shock absorption way to improve a shock absorption effect.

In addition, in the prior art, a common frame structure of a motorcycle often adopts the following way: the frame structure is formed by splicing and combining several forged pieces or pipe fittings. This way is troublesome to assemble because of needing welding, and the welding quality directly affects a structural strength. Secondly, the formed frame is fixed in size, which is not conducive to expansion of different battery sizes.

The above contents are only used to assist in understanding the technical solutions of the present application, which does not mean to admit that the above contents are the closest prior arts for the present application.

### SUMMARY OF THE PRESENT INVENTION

On this basis, the present application provides an off-road motorcycle.

The technical solution adopted by the present application to solve the technical problem is: an off-road motorcycle, which comprises a frame and a rear fork pivotally connected to the frame, wherein the frame is further provided with a first connection point and a second connection point, and the rear fork is further provided with a third connection point; the third connection point is used for pivotally connecting a middle end of a first connecting rod, and two ends of the first connecting rod are respectively provided with a fourth connection point and a fifth connection point; a shock absorber is arranged between the first connection point and the fifth connection point, and a second connecting rod is arranged between the second connection point and the fourth connection point; the first connection point, the second connection point, the fourth connection point, the third connection point and the fifth connection point are sequentially connected to form a line outline in a quadrilateral shape; and the first connecting rod is subjected to an acting force after deflection of the rear fork and the acting force is progressively dispersed to the second connecting rod until the acting force is transmitted to the shock absorber.

In some embodiments, the first connecting rod and the second connection point are non-rotationally connected; the first connecting rod and a fourth connection point are rotationally connected; and two ends of the shock absorber are rotationally connected with the first connection point and the fifth connection point.

In some embodiments, the shock absorber is a hydraulic shock absorber with a spring; the shock absorber comprises a piston sleeve, a telescopic rod, a reset spring and a liquid storage compartment; a first end of the telescopic rod is connected to the fifth connection point, and a second end of the telescopic rod is provided with a piston and extends into the piston sleeve to move; the reset spring is sleeved on a periphery of the piston sleeve and the telescopic rod for driving the telescopic rod to return; and the liquid storage compartment and the piston sleeve are arranged at an interval, and a flow channel is arranged between the liquid storage compartment and the piston sleeve for circulation of hydraulic oil.

In some embodiments, an opening of the liquid storage compartment is sealed by a sealing structure, the sealing structure comprises a sealing cover, a sealing plug, a locking cover and a locking screw, the sealing cover hermetically covers the opening of the liquid storage compartment, a middle portion of the sealing cover is provided with a through hole, the through hole is sealed by the sealing plug, the locking cover is threadedly connected to the sealing cover to limit the sealing plug, and the locking screw is threadedly connected to the locking cover, wherein sealing rings are respectively arranged between the sealing cover and an inner wall of the liquid storage compartment, between the locking cover and the sealing plug, and between the locking screw and the locking cover.

In some embodiments, the frame comprises a front section, a middle section and a rear section which are separately arranged; one end of the front section is provided with first connection portions respectively arranged at four end corners, two ends of the middle section are respectively provided with second connection portions and third connection portions respectively arranged at four end corners, one end of the rear section is provided with fourth connection portions respectively arranged at four end corners, and the first connection portions and the second connection portions, as well as the third connection portions and the fourth connection portions are connected through fasteners, so that a frame structure is integrated; and the middle section is a tank body closed on at least three sides, and an accommodating compartment for accommodating a battery is formed inside the frame structure after the front section, the middle section and the rear section are connected, and a size of the accommodating compartment is capable of being adjusted by replacing middle sections with different lengths.

In some embodiments, the first connection portion and the fourth connection portion are bosses with through holes, the second connection portion and the third connection portion are communicated with each other and provided with countersunk holes for matching with the bosses, the first connection portion, the second connection portion, the third connection portion and the fourth connection portion are penetrated by a long bolt to be connected, and a tail portion of the bolt is locked and fixed by a nut.

In some embodiments, an inner wall of the middle section is provided with a rib extending along a length direction, and a plurality of ribs are provided and arranged at intervals.

In some embodiments, the middle section comprises two symmetrical side plates and a bottom plate, the front section and the rear section are respectively provided with a first supporting plate and a second supporting plate which are connected with the bottom plate, and the first supporting plate, the bottom plate and the second supporting plate jointly form a bottom supporting surface of the storage compartment; and the second supporting plate comprises two vertically arranged supporting surfaces, which are respectively used for supporting a bottom portion and a rear portion of the battery.

In some embodiments, the frame comprises a front supporting portion and a rear supporting portion extending to one side, and an approximate V-shape is formed between the front supporting portion and the rear supporting portion,

a rear end of a seat cushion of the off-road motorcycle is rotationally connected to a tail end of the rear supporting portion, and a front end of the seat cushion is connected to a head end of the front supporting portion in an unlockable way, and

a hollow area is formed between the seat cushion and the frame.

In some embodiments, the seat cushion comprises a framework and a filling portion, the framework comprises a first supporting frame and a second supporting frame which are integrally formed and bent with each other, a bottom portion of the first supporting frame is tightly pressed on the front supporting portion, and the second supporting frame is suspended above the rear supporting portion.

In some embodiments, a plurality of reinforcing ribs are formed on a bottom surface of the framework.

In some embodiments, a front end of the framework is provided with a locking sheet with a hole, the head end of the front supporting portion is connected with a movable locking pin, and the locking pin is capable of being inserted into the hole in the locking sheet, so that the front end of the seat cushion is locked with the head end of the front supporting portion.

In some embodiments, a battery compartment is arranged in the frame, the battery is mounted in the battery compartment, a limiting block with a hook portion is mounted on the framework, and the limiting block is used for limiting a front portion of the battery.

The beneficial effects of the present application are as follows: firstly, by arranging two connecting rods in different positions, which are namely the first connecting rod and the second connecting rod, when a shock absorption action is needed, by means of a quadrilateral principle, the first connecting rod is subjected to an acting force after deflection of the rear fork and the acting force is progressively dispersed to the second connecting rod until the acting force is transmitted to the shock absorber, so as to form a two-stage acting force, thereby obtaining a better shock absorption effect. Secondly, the frame structure in segmented connection simplifies an assembly difficulty, and meanwhile, the middle section of the frame may be replaced to adapt to use of batteries with different lengths, thereby improving an expandability of product. Thirdly, the bottom portion of the seat cushion is provided with the hollow area, which makes the seat cushion have a rebound space, thereby improving the shock absorption effect to a certain extent; and the rear end of the seat cushion is rotationally connected with the frame in a non-dismountable way, and when the seat cushion is dismounted to use, only the front end of the seat cushion needs to be unlocked to turn over the seat cushion, thereby being convenient.

### DESCRIPTION OF THE DRAWINGS

In order to illustrate the technical solutions in the embodiments of the present application more clearly, the drawings which need to be used in describing the embodiments will be briefly introduced hereinafter. Apparently, the drawings described hereinafter are only some embodiments of the present application, those skilled in the art may obtain other drawings according to these drawings without going through any creative work.

FIG. 1 is a schematic diagram of a front structure of a frame of an off-road motorcycle.

FIG. 2 is a schematic diagram of a stereoscopic structure of the frame of the off-road motorcycle.

FIG. 3 is a schematic diagram of an internal structure of a shock absorber and a liquid storage compartment according to the present application;

FIG. 4 is a schematic structural diagram of the frame of the off-road motorcycle in a split state.

FIG. 5 is a schematic structural diagram of the frame of the off-road motorcycle in a connected state.

FIG. 6 is a schematic structural diagram of the frame of the off-road motorcycle in the connected state from another perspective.

FIG. 7 is a schematic structural diagram of the frame of the off-road motorcycle in a mounted state.

FIG. 8 is a schematic structural diagram of the frame of the off-road motorcycle in a dismantled state.

FIG. 9 is a schematic diagram of an internal structure of the frame of the off-road motorcycle.

Description of reference numerals: 1 refers to frame, 2 refers to rear fork, 31 refers to first connection point, 32 refers to second connection point, 33 refers to third connection point, 34 refers to fourth connection point, 35 refers to fifth connection point, 4 refers to shock absorber, 41 refers to piston sleeve, 42 refers to telescopic rod, 43 refers to reset spring, 44 refers to liquid storage compartment, 45 refers to flow channel, 46 refers to piston, 5 refers to first connecting rod, 6 refers to second connecting rod, 7 refers to sealing structure, 71 refers to sealing cover, 72 refers to sealing plug, 73 refers to locking cover, 74 refers to locking screw, and 8 refers to line outline;

1a refers to front section, 11a refers to first connection portion, 12a refers to first supporting plate, 2a refers to middle section, 21a refers to second connection portion, 22a refers to third connection portion, 23a refers to rib, 24a refers to side plate, 25a refers to bottom plate, 3a refers to rear section, 31a refers to fourth connection portion, 32a refers to second supporting plate, 321a refers to supporting surface, 4a refers to accommodating compartment, 5a refers to boss, 6a refers to countersunk hole, and 7a refers to fastener; and

11B refers to front supporting portion, 111b refers to inserted pin, 12b refers to rear supporting portion, 2b refers to seat cushion, 21b refers to framework, 211b refers to first supporting frame, 212b refers to second supporting frame, 213b refers to locking sheet, 214b refers to limiting block, 22b refers to filling portion, 3b refers to hollow area, and 4b refers to battery.

### DETAILED DESCRIPTION OF PREFERRED EMBODIMENTS

The technical solutions in embodiments of the present application are clearly and completely described hereinafter with reference to the drawings in the embodiments of the present application. Apparently, the described embodiments are merely some but not all of the embodiments of the present application. Based on the embodiments of the present application, all other embodiments obtained by those of ordinary skills in the art without going through any creative work should fall within the scope of protection of the present application. In addition, the technical solutions in the embodiments can be combined with each other, which should be on the basis that the technical solutions can be realized by those of ordinary skills in the art, when the combination of the technical solutions is contradictory or cannot be realized, it should be considered that the combination of the technical solutions does not exist and does not fall within the scope of protection of the present application.

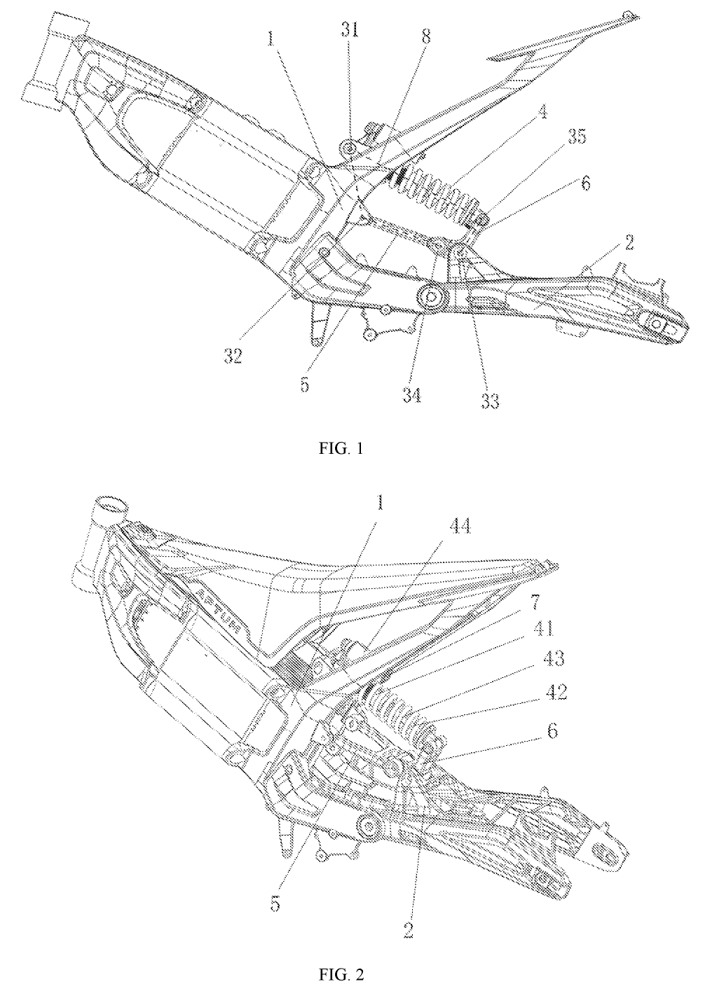

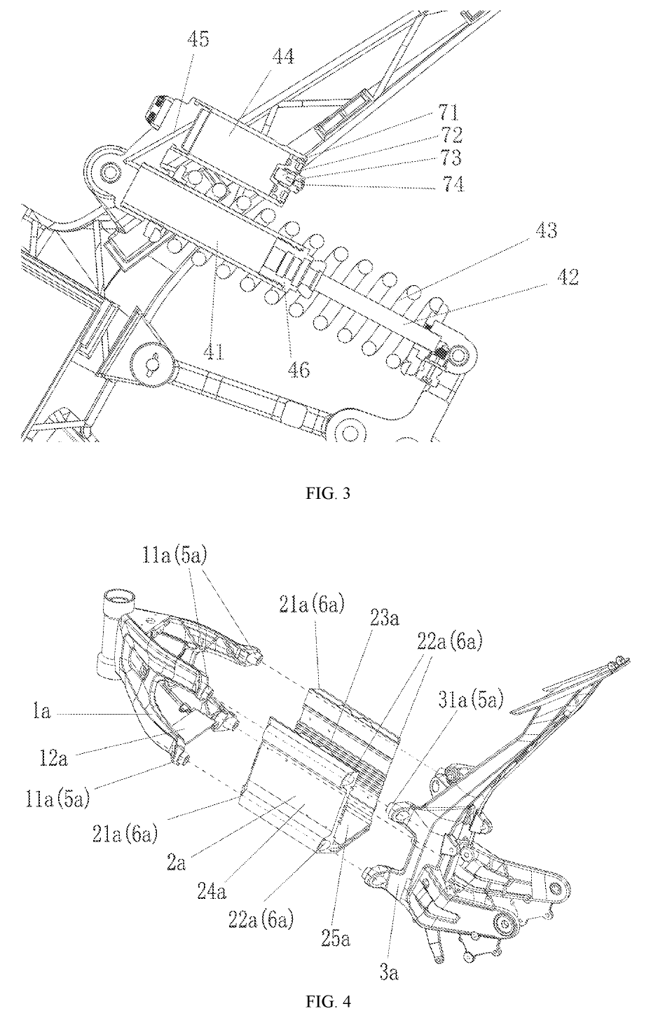

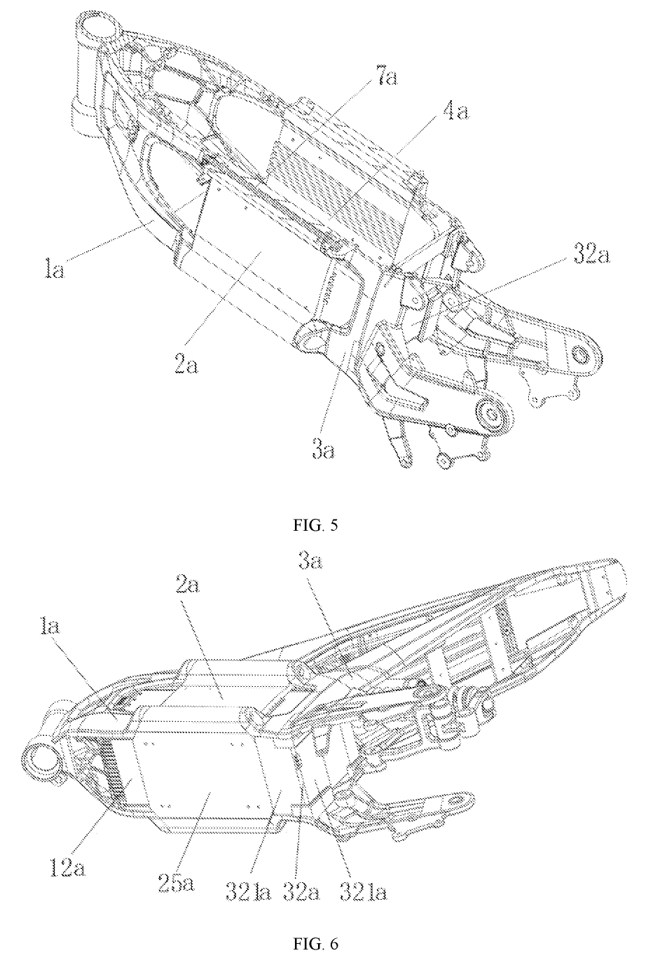

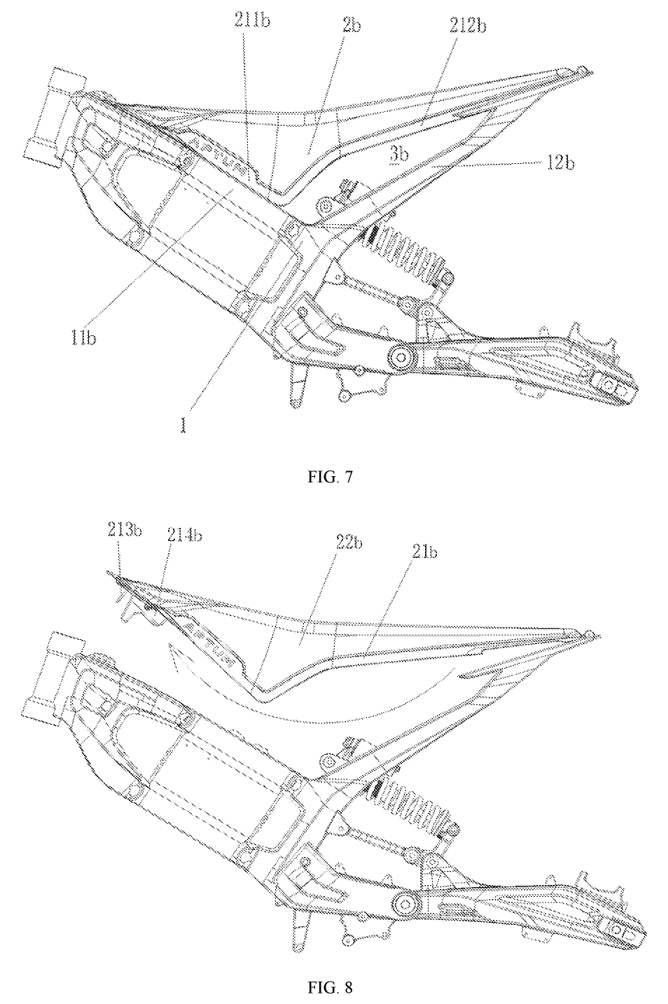

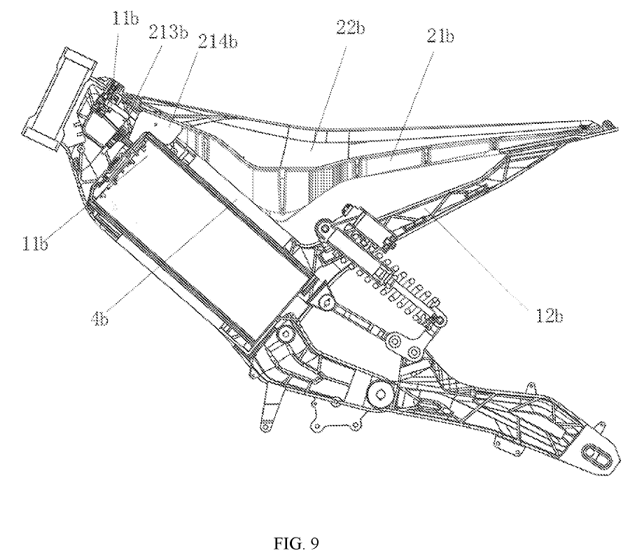

In an embodiment of the present application, with reference to FIG. 1 to FIG. 9, the present application provides an off-road motorcycle, which comprises a frame 1 and a rear fork 2 pivotally connected to the frame 1, wherein the frame is further provided with a first connection point 31 and a second connection point 32, and the rear fork 2 is further provided with a third connection point 33;

the third connection point 33 is used for pivotally connecting a middle end of a first connecting rod 5, and two ends of the first connecting rod 5 are respectively provided with a fourth connection point 34 and a fifth connection point 35;

a shock absorber 4 is arranged between the first connection point 31 and the fifth connection point 35, and a second connecting rod 6 is arranged between the second connection point 32 and the fourth connection point 34;

the first connection point 31, the second connection point 32, the fourth connection point 34, the third connection point 33 and the fifth connection point 35 are sequentially connected to form a line outline 8 in a quadrilateral shape; and

the first connecting rod 5 is subjected to an acting force after deflection of the rear fork 2 and the acting force is progressively dispersed to the second connecting rod 6 until the acting force is transmitted to the shock absorber 4.

Subsequently, some preferred/improved embodiments based on the above embodiment will be continuously described, and any one or a combination of several of the following embodiments may be used.

Preferably, the first connecting rod 5 and a fourth connection point 34 are rotationally connected. Two ends of the shock absorber 4 are rotationally connected with the first connection point 31 and the fifth connection point 35.

Preferably, the first connecting rod 5 and the second connection point 32 are non-rotationally connected Specifically, a front end of the first connecting rod 5 and the second connection point 32 are respectively provided with staggered steps, and the two steps are engaged with each other to realize non-rotation. In this way, an acting force exerted on a rear end of the first connecting rod 5 is more directly transmitted to the second connecting rod 6.

Preferably, the second connecting rod 6 is approximately L-shaped.

As one way, the shock absorber 4 is a hydraulic shock absorber with a spring.

Further, the shock absorber 4 comprises a piston sleeve 41, a telescopic rod 42, a reset spring 43 and a liquid storage compartment 44; a first end of the telescopic rod 42 is connected to the fifth connection point 35, and a second end of the telescopic rod is provided with a piston 46 and extends into the piston sleeve 41 to move; the reset spring 43 is sleeved on a periphery of the piston sleeve 41 and the telescopic rod 42 for driving the telescopic rod 42 to return; and the liquid storage compartment 44 and the piston sleeve 41 are arranged at an interval, and a flow channel 45 is arranged between the liquid storage compartment 44 and the piston sleeve 41 for circulation of hydraulic oil.

Further, an opening of the liquid storage compartment 44 is sealed by a sealing structure 7, the sealing structure 7 comprises a sealing cover 71, a sealing plug 72, a locking cover 73 and a locking screw 74, the sealing cover 72 hermetically covers the opening of the liquid storage compartment 44, a middle portion of the sealing cover 72 is provided with a through hole, the through hole is sealed by the sealing plug 72, the locking cover 73 is threadedly connected to the sealing cover 72 to limit the sealing plug 72, and the locking screw 74 is threadedly connected to the locking cover 73, wherein sealing rings are respectively arranged between the sealing cover 72 and an inner wall of the liquid storage compartment 44, between the locking cover 73 and the sealing plug 72, and between the locking screw 74 and the locking cover 73. In this way, an oil level of the liquid storage compartment may be adjusted or supplemented.

Further, the present application provides a split-type connected frame structure of the off-road motorcycle, the frame 1 comprises a front section 1a, a middle section 2a and a rear section 3a which are separately arranged; one end of the front section 1a is provided with first connection portions 11a respectively arranged at four end corners, two ends of the middle section 2a are respectively provided with second connection portions 21a and third connection portions 22a respectively arranged at four end corners, one end of the rear section 3a is provided with fourth connection portions 31a respectively arranged at four end corners, and the first connection portions 11a and the second connection portions 21a, as well as the third connection portions 22a and the fourth connection portions 31a are connected through fasteners 7a, so that a frame structure is integrated; and the middle section 2a is a tank body closed on at least three sides, and an accommodating compartment 4a for accommodating a battery is formed inside the frame structure after the front section 1a, the middle section 2a and the rear section 3a are connected, and a size of the accommodating compartment 4a is capable of being adjusted by replacing middle sections with different lengths.

A specific matching way of connection is as follows: the first connection portion 11a and the fourth connection portion 31a are bosses 5a with through holes, the second connection portion 21a and the third connection portion 22a are communicated with each other and provided with countersunk holes 6a for matching with the bosses 5a, the first connection portion 11a, the second connection portion 21a, the third connection portion 22a and the fourth connection portion 31a are penetrated by a long bolt to be connected, and a tail portion of the bolt is locked and fixed by a nut. The arrangement of the bosses and the countersunk holes can realize rapid butt joint during assembly.

Preferably, an inner wall of the middle section 2a is provided with a rib 23a extending along a length direction, and a plurality of ribs 23a are provided and arranged at intervals. After the battery is mounted, these ribs 23a are in contact with an outer surface of the battery, which are conductive to heat dissipation of the battery, and meanwhile, the arrangement of the ribs 23a can improve an overall strength of the middle section.

Specifically, the middle section 2a comprises two symmetrical side plates 24a and a bottom plate 25a, the front section 1a and the rear section 3a are respectively provided with a first supporting plate 12a and a second supporting plate 32a which are connected with the bottom plate 25a, and the first supporting plate 12a, the bottom plate 25a and the second supporting plate 32a jointly form a bottom supporting surface of the storage compartment 4a. In this way, a bottom supporting area of the battery is increased.

Further, the second supporting plate 32a comprises two vertically arranged supporting surfaces 321a, which are respectively used for supporting a bottom portion and a rear portion of the battery. In this way, the protection of the battery is improved.

In another aspect, the present application provides a seat cushion structure for the off-road motorcycle, the frame comprises a front supporting portion 11b and a rear supporting portion 12b extending to one side, and an approximate V-shape is formed between the front supporting portion 11a and the rear supporting portion 12a. A rear end of a seat cushion 2b is rotationally connected to a tail end of the rear supporting portion 12b, and a front end of the seat cushion 2b is connected to a head end of the front supporting portion 11b in an unlockable way. A hollow area 3b is formed between the seat cushion 2b and the frame 1. This design not only improves a flexibility of the seat cushion, which allows a user to adjust a sitting posture as needed, but also provides the hollow area 3b, which is conductive to reducing an overall weight and provides better ventilation. Meanwhile, one-sided rotating connection also makes the assembly and disassembly of the seat cushion 2b more convenient.

In some embodiments, the seat cushion 2b comprises a framework 21b and a filling portion 22b, the framework 21b comprises a first supporting frame 211b and a second supporting frame 212b which are integrally formed and bent with each other, a bottom portion of the first supporting frame 211b is tightly pressed on the front supporting portion 11b, and the second supporting frame 212b is suspended above the rear supporting portion 12b. This design not only enhances a durability and a strength of the seat cushion, but also reduces an unnecessary weight by optimizing material distribution, thereby improving riding comfort.

In some embodiments, a plurality of reinforcing ribs are formed on a bottom surface of the framework 21b. The added reinforcing ribs effectively improve the bending resistance of the framework, and ensure the structural integrity even under extreme conditions, thereby increasing the service life of product.

In some embodiments, a front end of the framework 21b is provided with a locking sheet 213b with a hole, the head end of the front supporting portion 11b is connected with a movable locking pin 111b, and the locking pin 111b is capable of being inserted into the hole in the locking sheet 213b, so that the front end of the seat cushion 2b is locked with the head end of the front supporting portion 11b. As one embodiment, the locking pin 111b is driven by a rotatable cam bit, and meanwhile, the cam bit is driven by a key. This locking mechanism is simple and effective, provides a possibility of quick disassembly and assembly, is convenient for maintenance, and also ensures the safety during driving at the same time.

In some embodiments, a battery compartment 4b is arranged in the frame 1, the battery is mounted in the battery compartment 4b, a limiting block 214b with a hook portion is mounted on the framework 21b, and the limiting block 214b is used for limiting a front portion of the battery. The design of the limiting block ensures safe fixation of the battery, which avoids the problem of battery displacement or damage caused by vibration, thereby improving use safety.

At this point, various embodiments of the present application have been described in detail. In order to avoid obscuring the concept of the present application, some details well known in the art have not been described. Those skilled in the art can fully understand how to implement the technical solutions disclosed herein according to the above description.

We claim:

1. An off-road motorcycle, comprising a frame and a rear fork pivotally connected to the frame, wherein the frame is further provided with a first connection point and a second connection point, and the rear fork is further provided with a third connection point; the third connection point is used for pivotally connecting a middle end of a first connecting rod, and two ends of the first connecting rod are respectively provided with a fourth connection point and a fifth connection point; a shock absorber is arranged between the first connection point and the fifth connection point, and a second connecting rod is arranged between the second connection point and the fourth connection point; the first connection point, the second connection point, the fourth connection point, the third connection point and the fifth connection point are sequentially connected to form a line outline in a quadrilateral shape; and the first connecting rod is subjected to an acting force after deflection of the rear fork and the acting force is progressively dispersed to the second connecting rod until the acting force is transmitted to the shock absorber.

2. The off-road motorcycle according to claim 1, wherein the first connecting rod and the second connection point are non-rotationally connected; the first connecting rod and a fourth connection point are rotationally connected; and two ends of the shock absorber are rotationally connected with the first connection point and the fifth connection point.

3. The off-road motorcycle according to claim 1, wherein the shock absorber is a hydraulic shock absorber with a spring; the shock absorber comprises a piston sleeve, a telescopic rod, a reset spring and a liquid storage compartment; a first end of the telescopic rod is connected to the fifth connection point, and a second end of the telescopic rod is provided with a piston and extends into the piston sleeve to move; the reset spring is sleeved on a periphery of the piston sleeve and the telescopic rod for driving the telescopic rod to return; and the liquid storage compartment and the piston sleeve are arranged at an interval, and a flow channel is arranged between the liquid storage compartment and the piston sleeve for circulation of hydraulic oil.

4. The off-road motorcycle according to claim 3, wherein an opening of the liquid storage compartment is sealed by a sealing structure, the sealing structure comprises a sealing cover, a sealing plug, a locking cover and a locking screw, the sealing cover hermetically covers the opening of the liquid storage compartment, a middle portion of the sealing cover is provided with a through hole, the through hole is sealed by the sealing plug, the locking cover is threadedly connected to the sealing cover to limit the sealing plug, and the locking screw is threadedly connected to the locking cover, wherein sealing rings are respectively arranged between the sealing cover and an inner wall of the liquid storage compartment, between the locking cover and the sealing plug, and between the locking screw and the locking cover.

5. The off-road motorcycle according to claim 1, wherein the frame comprises a front section, a middle section and a rear section which are separately arranged; one end of the front section is provided with first connection portions respectively arranged at four end corners, two ends of the middle section are respectively provided with second connection portions and third connection portions respectively arranged at four end corners, one end of the rear section is provided with fourth connection portions respectively arranged at four end corners, and the first connection portions and the second connection portions, as well as the third connection portions and the fourth connection portions are connected through fasteners, so that a frame structure is integrated; and the middle section is a tank body closed on at least three sides, and an accommodating compartment for accommodating a battery is formed inside the frame structure after the front section, the middle section and the rear section are connected, and a size of the accommodating compartment is capable of being adjusted by replacing middle sections with different lengths.

6. The off-road motorcycle according to claim 5, wherein the first connection portion and the fourth connection portion are bosses with through holes, the second connection portion and the third connection portion are communicated with each other and provided with countersunk holes for matching with the bosses, the first connection portion, the second connection portion, the third connection portion and the fourth connection portion are penetrated by a long bolt to be connected, and a tail portion of the bolt is locked and fixed by a nut.

7. The off-road motorcycle according to claim 5, wherein an inner wall of the middle section is provided with a rib extending along a length direction, and a plurality of ribs are provided and arranged at intervals.

8. The off-road motorcycle according to claim 5, wherein the middle section comprises two symmetrical side plates and a bottom plate, the front section and the rear section are respectively provided with a first supporting plate and a second supporting plate which are connected with the bottom plate, and the first supporting plate, the bottom plate and the second supporting plate jointly form a bottom supporting surface of the storage compartment; and the second supporting plate comprises two vertically arranged supporting surfaces, which are respectively used for supporting a bottom portion and a rear portion of the battery.

9. The off-road motorcycle according to claim 1, wherein,
the frame comprises a front supporting portion and a rear supporting portion extending to one side, and an approximate V-shape is formed between the front supporting portion and the rear supporting portion,
a rear end of a seat cushion of the off-road motorcycle is rotationally connected to a tail end of the rear supporting portion, and a front end of the seat cushion is connected to a head end of the front supporting portion in an unlockable way, and
a hollow area is formed between the seat cushion and the frame.

10. The off-road motorcycle according to claim 9, wherein the seat cushion comprises a framework and a filling portion, the framework comprises a first supporting frame and a second supporting frame which are integrally formed and bent with each other, a bottom portion of the first supporting frame is tightly pressed on the front supporting portion, and the second supporting frame is suspended above the rear supporting portion.

11. The off-road motorcycle according to claim 9, wherein a plurality of reinforcing ribs are formed on a bottom surface of the framework.

12. The off-road motorcycle according to claim 9, wherein a front end of the framework is provided with a locking sheet with a hole, the head end of the front supporting portion is connected with a movable locking pin, and the locking pin is capable of being inserted into the hole in the locking sheet, so that the front end of the seat cushion is locked with the head end of the front supporting portion.

13. The off-road motorcycle according to claim 9, wherein a battery compartment is arranged in the frame, the battery is mounted in the battery compartment, a limiting block with a hook portion is mounted on the framework, and the limiting block is used for limiting a front portion of the battery.
